(19) United States
(12) Patent Application Publication
(10) Pub. No.: US 2005/0010556 A1
(43) Pub. Date: Jan. 13, 2005

(54) Method and apparatus for information retrieval

(76) Inventor: Kathleen Phelan, Ripponlea (AU)

Correspondence Address: KLAUBER & JACKSON, 411 HACKENSACK AVENUE, HACKENSACK, NJ, 07601, US

(21) Appl. No.: 10/496,811

(22) PCT Filed: Nov. 27, 2002
(86) PCT No.: PCT/AU02/01597

(30) Foreign Application Priority Data
Nov. 27, 2002 (AU) PR9146

(51) Int. Cl. G06F 17/30

(52) U.S. Cl. 707/3

(57) ABSTRACT

A method for automated search and retrieval of information available on a networked database, the method including the steps of providing search topic information, providing a target information resource location, spidering or dividing the target information resource location for further resource locations that are likely to lead to relevant information, and retrieving information from the target information resource location or from a relevant one of the further resource locations.

### FIELD OF THE INVENTION

This invention relates to information retrieval, and is directed primarily but not solely to automated retrieval and analysis of information available on the Internet or similar databases such as databases, internal networks and intranets.

### BACKGROUND OF THE INVENTION

Computer databases, internal networks, intranets, networks and, in particular, the network of networks such as that commonly referred to as the Internet have resulted in vast amounts of information being publicly available on those sources. However, for example, there is no single organised and completely up-to-date repository or index of all information on the Internet.

To be useful, information must be relevant and timely. The Internet makes information easy to access, but it can be a very difficult task to fully canvas the Internet to find all information that is relevant to a particular topic or range of topics. Also, with information being accumulated and changed so rapidly due to the Internet environment, even if extensive searching is performed in a manual procedure, then the time taken to search in this manner is quite likely to not be fully up to date.

There are a number of Internet search engines, such as “Yahoo™” for example which attempt to provide a user friendly search facility for information on the Internet or similar databases. However, these search engines try to cover a full range of topics from many disparate sources and are therefore not continually up to date. They also index on a frequency of only 4 to 12 weeks.

### OBJECT OF THE INVENTION

It is an object of the present invention to provide methods or apparatus for information retrieval and/or analysis and/or user information alerts which will at least go some way toward overcoming disadvantages of known apparatus and methods, or which will at least provide the public with a useful choice.

Throughout this specification, where there is a description with reference to the Internet, it should be appreciated that the invention is applicable also to databases, internal networks, intranets and the like.

### SUMMARY OF THE INVENTION

In one broad aspect the invention provides a method for automated search and retrieval of information available on a networked database, the method including the steps of
providing search topic information,
providing a target information resource location,
spidering or dividing the target information resource location for further resource locations that are likely to lead to relevant information, and
retrieving information from the target information resource location or from a relevant one of the further resource locations.

Preferably the network is the Internet.

Preferably the retrieved information is analysed.

Preferably an alert is provided to an entity as a result of the analysis.

In another broad aspect the invention provides an automated information search and retrieval system in which real time selection and retrieval of the information occurs.

Preferably the system includes provision for archiving the retrieved information in a readily accessible manner.

It is preferred that the information is searched and retrieved from the Internet.

In a further aspect the invention provides a method for automated searching and retrieval of information, performing real time selection and retrieval of the information.

Preferably the information is archived for subsequent analysis.

The method preferably includes the step of establishing one or more target resource locations from which information is to be searched and retrieved.

Furthermore, the target location preferably includes a URL which is spidered by the system to identify underlying links.

Preferably the spidering step is performed in a plurality of passes, each pass being targeted toward certain links, and each pass ignoring links that are unlikely to be relevant.

Preferably the method includes the step of retrieving information from links that appear relevant.

Preferably the method includes the step of assigning or attaching metadata to each item of information to create a database record.

Preferably the database records are archived.

Preferably retrieved information which is not in a textual format is converted to an editable raw-text data type.

Preferably data can be provided from other sources, for example hard copies which may be converted to text using optical character recognition processors, or from an audio format using speech recognition applications.

Preferably the method includes the step of analysing text retrieved by the method against predetermined rules. The predetermined rules may include a literal string (key word) matches, regular expression matches, string patterns or occurrences of text, or other linguistically defined criteria. The predetermined rules may additionally involve other text analysis technology to recognise desired matches. The rules may be used to implement a criterion against which retrieved items of information are compared to determine their relevance to various topics and therefore the manner in which the information should be indexed, or possibly discarded.

Preferably the method includes the step of discarding or stripping all extraneous information from the information that is retrieved. Such extraneous information may include HTML tags, images and the like.

Preferably relevant information which is the subject of a new record created for immediate analysis or for archiving is stored with associated metadata (for example source URL, data retrieved, string length, HTML headers and the like). Furthermore, preferably each record is a distinct and unique item in the database or archive and is assigned a unique identifier.

The unique identifier may be a thirty two character UUID (universally unique identifier).

The invention also includes apparatus to implement the system or method of one or more of the preceding statements of invention.

The invention includes a computing machine operable to implement the system or method of one or more of the preceding statements of invention.

To those skilled in the art to which the invention relates, many changes in constructions and widely different embodiments and applications of the invention will suggest themselves without departing from the scope of the invention as defined in the appended claims. The disclosure and descriptions herein are purely illustrative and are not intended to be in any sense limiting.

The invention consists of the foregoing and also envisages constructions of which the following gives examples only.

### DRAWINGS DESCRIPTION

One presently preferred embodiment of the invention will now be described with reference to the accompanying drawings, wherein;

FIG. 1 an overview diagram of an information retrieval and archiving system according to the invention,

FIG. 2 is a diagrammatic time line of internet information search functions according to the invention.

FIG. 3 is a flow diagram of an internet search and retrieval function according to the invention.

FIGS. 4a & 4b constitute a single flow diagram showing the search and retrieval function of FIG. 3 in greater detail.

FIG. 5 is a diagram showing the action of an agent or bot spidering a target server in accordance with the invention.

### DESCRIPTION OF PREFERRED EMBODIMENTS

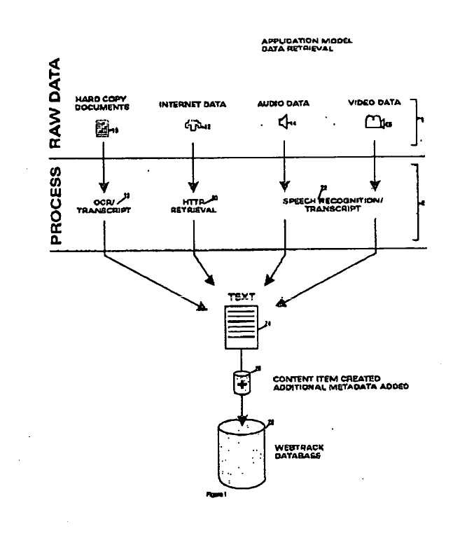

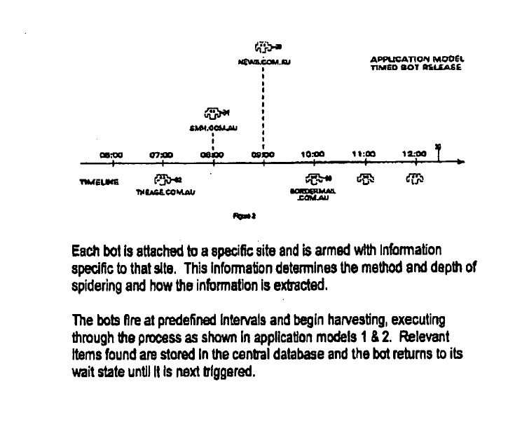

Referring to FIG. 1, an overview of a method or system and associated apparatus according to the present invention is shown. Raw data is shown at a first level referenced 1. It is this data that the present invention searches, selects and then organises or indexes to arrive at relevant timely information. As can be seen from the diagram, this raw data can include a diverse range of data formats such as hard copy documents 10, Internet data 12, audio data 14 and video data 16.

Sources of hard copy documents include sources such as newspapers and magazine articles or other paper records.

Internet or other network data can include data contained in or generated by HTML documents, XML documents/feeds, dynamic pages (CGI, ASP, CFM, PHP) and WAP data sources, amongst others.

Audio data can include radio broadcasts, tape recordings/interviews and streaming audio (for example provided on the Internet).

Video data can include television broadcasts, tape recordings or streaming video (for example provided on the Internet).

At level 2 in FIG. 1, a data processing level is shown. For hardcopy documents the preferred processing is performed by an optical character recognition (OCR) application. This is indicated with reference number 18 in FIG. 1. OCR uses high definition scanners to capture an image of a hard copy document and convert it to a raw text format. To facilitate OCR, a computer or series of computers to which a high-resolution scanning device/s (with a bulk feeder mechanism into which many pages of documents can be loaded) is attached.

The application automatically scans each page, converts the document into a raw text format using OCR (optical character recognition), and saves it into the central database.

The documents may be newspaper articles, magazine journals, printed PDF files, or other hard-copy material.

To process Internet data, HTTP (and similar or subsequent methods and protocols) requests are used to supply the required HTML, or other, documents and these can then be stripped of extraneous information such as HTML tags and the like to arrive at a text document. This processing is generally indicated using reference numeral 20 in FIG. 1.

Audio data and video data are processed using speech recognition components to transform the audio information into a textual format. This process is generally indicated using reference numeral 22 in FIG. 1. To facilitate speech recognition/transcription, a computer or series of computers running an application which processes audio from TV broadcasts, video, and other media (streaming, CDROM, etc). The audio/video data may be stored digitally on a storage device connected to the computer or captured from an analogue source such as a bank of VCRs or similar playback devices.

The “audio signal” can be derived from either an audio or video source. Provision is made for additional metadata with video sources that analyses and classifies video & image information.

The application running on the computer analyses the broadcast using speech recognition software to convert it to a raw text form where it is saved into the central database.

The result of the processing step in level 2 is a text document, referenced 24 which is provided in electronic form. Each text item 24 then has metadata added to it (as will be described further below) so as to create a database record in step 26, and each record is then stored on a database 28. The database can then be accessed to review information of interest that has been gathered using the process. Furthermore, the information on the database can be archived in a number of convenient formats for use to track changes and patterns over time or to review historical data information.

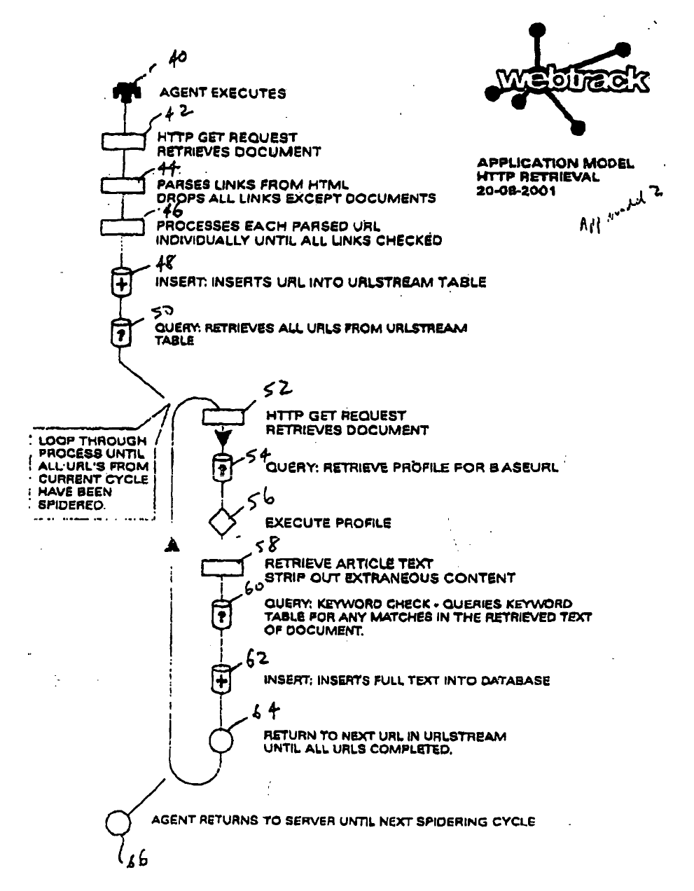

Although the system may be used with a wide variety of sources of raw data, as described with reference to FIG. 1, an immediate application of the invention is to Internet data, and this is indicated in FIG. 2 and will be described further by way of example with reference to the remaining figures.

Turning now to FIG. 2, a time line having an axis 30 representing time advancing in linear intervals in a direction to the right hand side of the figure shows examples of agents or bots which automatically search target data sources on the Internet.

Agents or bots (or similar kinds of automated agents) are used in the preferred embodiment to automatically search target data sources on the Internet. The agents are released periodically.

By way of example, at 7:00 am, a first agent 32 which has the task of extracting information from a specific URL e.g. theage.com may be released. Each agent is attached to a specific site and is profiled with information specific to that site. The information determines the method and depth of spidering (this will be explained further below) and how the information is extracted.

Each agent is released at predetermined intervals and they begin harvesting information through a process as will be described further below. Once each agent has finished its automated process, it returns to a “wait” state until it is next triggered.

Therefore, to continue with the example, another agent 34 may be attached to another URL e.g. SMH.com and be released at 8:00 am. The agent 36 may be attached to a URL e.g. news.com.au and be released at 9:00 am. The agent 38 may be attached to yet another URL e.g. ordermail.com.au and be released at 10:00 am.

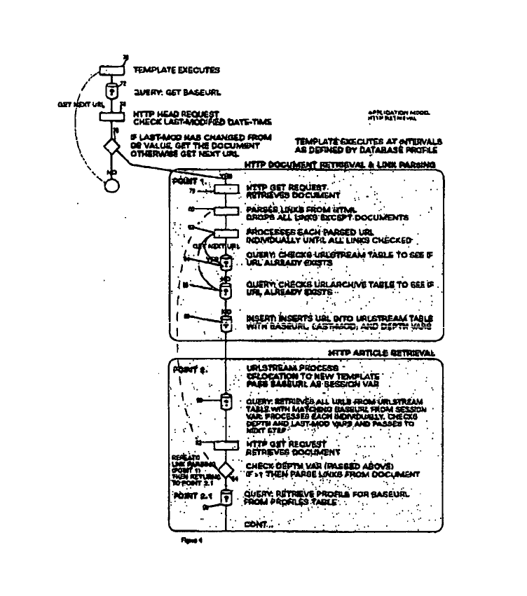

Turning now to FIG. 3, a general process flow is described beginning at step 40 when the agent begins operation. Firstly, the agent makes an http get request to retrieve the HTML document from its target URL. This is performed in step 42. In the example given in FIG. 2, if the agent in step 40 is agent 32, then the URL that the request is sent to would be theage.com.au.

Almost invariably, the document that the agent receives from the target URL will include a number of links. These links will typically consist of links to other URLs. These links are filtered according to certain criteria and information the agent is loaded with and stored on a system server in a “spider list”. Certain types of resource are filtered as well as compared to an “exclusion list” on the server. Any URL which is listed on the exclusion list is ignored by the agent. In this way, from a general known website structure, links which are known to be valueless in terms of their information can be readily excluded by the system. This step of filtering the relevant links is carried out in step 44 and is generally performed by a parsing process whereby the text and the link is analysed by the agent to look for key words or known words or word patterns such as linguistically defined criteria or “themes” which are likely to indicate a relevant link to the information which is sought. The method includes the step of analysing text retrieved by the method against predetermined rules. The predetermined rules may include a literal string (key word) matches, regular expression matches, string patterns or occurrences of text, or other linguistically defined criteria. The predetermined rules may additionally involve other text analysis technology to recognise desired matches. The rules may be used to implement a criterion against which retrieved items of information are compared to determine their relevance to various topics and therefore the manner in which the information should be indexed, or possibly discarded. The term “spidering” refers to the process of navigating through a series of on line resources and gathering information. Therefore, the spider list which is established by the agent sets forth a pattern of links at the target site which is subsequently visited by the agent to retrieve information as is described further below.

In step 46 the agent then proceeds to process each parsed URL from step 44 individually until all further links (of which there may be many) are checked in this manner. This occurs in step 46. Again, links which are on the exclusion list are ignored by the agent.

As each URL is parsed, the agent inserts the relevant URL (or link) into a URL string table. This occurs in step 48.

Once the spidering process has been completed, the agent then performs a query in step 50 to retrieve all the URL's from the URL stream table.

The next general step is for the agent to look through a document retrieval process until all the URLs or links from the URL stream table have been accessed i.e. spidered. Therefore, in step 52 the process begins by the agent making an HTTP GET request to retrieve a document from the first URL. The agent then retrieves a profile for the base URL. This occurs in step 54 and the purpose is to obtain further information about any known document structure or structures at the website of interest. Therefore, profiles tend to be specific toward each target URL. If the profile is known, then this can make the content of the HTML document much easier to accurately retrieve in a desired form. If the structure of the HTML document retrieved does not match the profile then the agent defaults to retrieving the entire text from the HTML document with the HTML tags stripped out.

Therefore, in step 56, the agent executes the profile and in step 58 retrieves the relevant material (for example) in text with extraneous content stripped out.

The next step 60 is for an analysis to be performed of the retrieved document. The agent analyses the text retrieved against predetermined rules which may be called “themes” stored on the system server. The themes may consist of actual literal string (i.e. key word) matches, regular expression matches, string patterns or occurrences of text or other linguistically defined criteria as determined.

In practice, themes are defined by system users in consultation with analysts and may consist of any of the foregoing, and additionally may involve other text analysis technology to recognise desired matches. The word “themes” is broadly used in this document to describe a scheme of criteria against which retrieved items are compared to ascertain or distil documents of relevance to the user.

Returning to FIG. 3, should the query performed in step 60 result in a match, then the agent inserts the text document that has been retrieved into the system database. This occurs in step 62. If a match is not achieved, then the document is discarded.

Having retrieved one document, the agent then returns to the next URL in the URL stream table in step 64 so that the process begins to repeat from step 52 until all URLs have been examined.

Once the spidering process is complete, the agent “returns” to the system server until the next cycle is due to begin. This is represented as step 66 in FIG. 3. As described with reference to FIG. 1, as each text item is added to the database, additional metadata is added to the item so that the data is organised or indexed for subsequent retrieval or for further analysis for identification purposes. Therefore, as each new record is created on the system's database, the text is stored and any associated metadata (such as source URL, date retrieved, string length, HTML headers etc) is stored with the text. Each record is created is thus a distinct and unique item in the data base and is assigned a unique identifier. This identifier preferably takes the form of 32 character UUID.

The system envisages storing text documents regardless of whether a theme is matched or not so that recursive searches may be made.

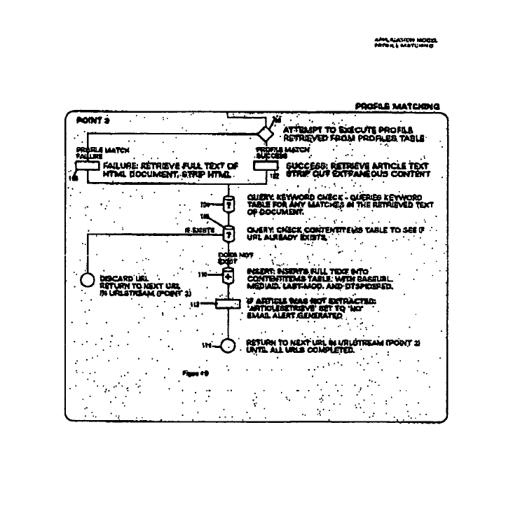

Turning now to FIGS. 4a and 4b, a further example of spidering a target base URL is provided, using the methodology similar to that described with reference to FIG. 2, but incorporating some more detail. Thus in FIG. 4a, the agent executes in step 70 and an initial query occurs in step 72 which is an HTTP request to get the base URL. In step 74 a check is performed from the document returned as a result of the request. This check is to review the header data from the HTML document that is returned to ascertain the last time that the document was updated or modified. A comparison occurs in step 76, and if there is no change, then the agent returns to step 70. However, if a change has occurred, then the document is received in step 78 and is parsed in step 80 to ascertain relevant links. It is desired (but not absolutely necessary) that only links which relate to text documents are parsed and that the agent ignores links from any exclusion list as described above.

In step 82 the parsed URL is processed and in step 84 the agent performs a query to check whether the processed URL is present in the URL stream table. If it is not, then in step 86 a further query is performed to check whether the URL is in the URL archive table. If the URL is not present in that table either, then the agent inserts the URL into the URL stream table together with further parameters such as the base URL, the date and time of last modification of the document to which the URL relates and a depth variable.

If the URL is identified in steps 84 or 86, then the agent continues to process the next URL in step 82 and the process continues until all the URL's have been parsed.

The process continues in step 90 when the agent retrieves all the URL's that have been passed from the URL stream table. A GET request is then performed in step 92 for the first URL from the URL stream table. A check is then performed in step 94 to see whether the depth variable is greater than 1 i.e. whether there are further links in the document that is retrieved from that URL. If there is, then these links are parsed and the process is performed again beginning at step 80 until all the subsidiary links are parsed and then the agent returns to step 96 where a query is performed to retrieve the profile for the relevant base URL.

The process flow continues in FIG. 4b where in step 98 the agent attempts to execute the retrieved profile. If there is a profile match failure, as shown in step 100, then the full text of the HTML document is simply retrieved and all the HTML tags are simply stripped from the document. If there is a profile match success as shown in step 102, then the text from the document is easily retrieved with extraneous content removed from it. The resultant text document is then compared with the themes referred to above to see whether a match occurs in step 104. A query is then performed in step 106 to see whether the URL to which the document relates already exists. If it does, then the URL is discarded and the agent turns to the next URL in the URL stream table at step 108. However, if the URL does not already exist, then the agent inserts the full text into the content items table (i.e. into the database) together with further metadata such as the base URL and further information for identification and search purposes. This occurs in step 110.

If for some reason an article cannot be extracted, then an email is generated in step 112. The agent then continues to repeat the process for subsequent URL's in the URL stream table at step 114.

Step 106 has the purpose of preventing information being retrieved and stored twice.

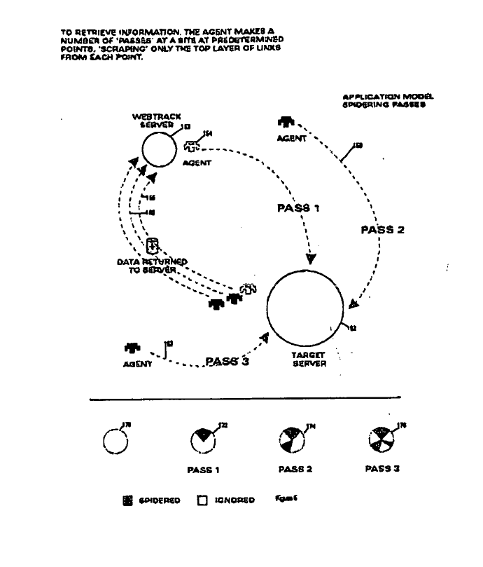

In FIG. 5, a simplified diagrammatic illustration of the spidering process described above in FIGS. 3, 4a and 4b is shown. The system server is referenced 150 and a target server on which the target URL i.e. the base URL referred to above is located as referenced 152. An agent 154 begins by making a first pass of the base URL of the target server 152. That agent then returns data to the server as shown by arrow 156. If the information returned indicates that there are links to further URL's on the target server, then the agent makes a further pass i.e. a second pass 158. Information from the second parse is returned to the server in step 160. Again, if the second pass shows that further links are present on the server, then a third pass 162 may be made, which will again return further information to the server. Of course, a large number of parses may be made if required. The method provides a logical and straight forward way of spidering a target server for relevant information. As can further be seen from FIG. 5, information on a target server may be represented in a pie chart form. The information in an initial state of the server 170 may show that no information has been spidered. After the first pass, a certain amount of information will have been retrieved as indicated in diagram 172. After a second pass further information will have been retrieved as shown by diagram 174. Finally, after the third pass, yet more information has been retrieved as shown by diagram 176. The spidered information from the server is shown in the shaded portions of each diagram. As can be seen, a certain amount of information is ignored and this information relates to links that have been parsed by the agent but which have been ignored because they have been determined to be a) irrelevant, b) on a list of URL's to be ignored, or c) are not in the required data form (for example do not comprise a text document).

After a content item has been stored in the database, an “alert” will be generated. The alert configuration is definable by the client, and may take the form of an email, an SMS message, the remote updating of a web page, or remote communication with another database system of application.

The alert may be sent in “real-time” (as soon as the content item is retrieved) or after it has been analysed (after the analyst has processed the content item).

The alerts may be received singly or in digest form on a different frequency, for example, daily, weekly, or even monthly if desired.

The client may view “real-time” reports sowing visually the retrieval, processing and analysis of items that match their keyword themes. These reports consist of dynamic bar graphs, pie graphs, and other types of chart which display information and metadata pertaining to these contents items. The client may further manipulate these charts and graphs with different ranges and criteria to produce different results.

The analysis may be performed by a human analyst or by a software component on the server. The analysis metadata is compiled from the client perspective and stored on a per-user client; so one content item may have many analyses for different clients.

The analysis allows the user to select many database cross-sections for different reports showing the analysis metadata which is linked to retrieved content items. The analysis will also be displayed real-time to the client so as items are updated and analysed the on-screen information is updated with no intervention from the client.

The analysis enables the user to quickly gain an understanding of the skew of a large volume of content at a glance; instead of perusing each item they are able to view a dissective overview in graphical format and provide a powerful tool in determining real-time trends as they appear.

From the foregoing it will be seen that a system for retrieving relevant and timely information and archiving information in a form which is readily searchable and may be analysed, is provided. In particular, a methodical and efficient method of spidering target websites is provided. Also, a method of discarding irrelevant information to arrive at document in text format is provided, together with a method of indexing or organising and identifying retrieved documents for subsequent analysis. Finally a system of conveniently and timely alerting users for the presence of information relevant to them is provided.

1. A method for automated search and retrieval of information available on a networked database, the method including the steps of
providing search topic information,
providing a target information resource location,
spidering or dividing the target information resource location for further resource locations that are likely to lead to relevant information, and
retrieving information from the target information resource location or from a relevant one of the further resource locations.

2. A method according to claim 1 in which the networked database is the Internet.

3. A method according to claim 2 in which the retrieved information is analysed analyzed.

4. A method according to claim 3 in which an alert is provided to an entity as a result of the analysis.

5. A method for automated searching and retrieval of information, performing real time selection and retrieval of the information.

6. A method according to claim 5 in which the information is archived for subsequent analysis.

7. A method according to claim 6 including the step of establishing one or more target resource locations from which information is to be searched and retrieved.

8. A method according to claim 7 in which the target location includes a URL which is spidered by the system to identify underlying links.

9. A method according to claim 8 in which the spidering step is performed in a plurality of passes, each pass being targeted toward certain links, and each pass ignoring links that are unlikely to be relevant.

10. A method according to claim 9 including the step of retrieving information from links that appear relevant.

11. A method according to claim 10 including the step of assigning or attaching metadata to each item of information to create a database record.

12. A method according to claim 11 in which the database records are archived.

13. A method according to claim 12 in which retrieved information which is not in a textual format is converted to an editable raw-text data type.

14. A method according to claim 13 including the step of analyzing retrieved text against predetermined rules to recognize desired matches.

15. A method according to claim 14 in which the rules are used to implement a criterion against which retrieved items of information are compared to determine their relevance to various topics and therefore the manner in which the information should be indexed, or possibly discarded.

16. A method according to claim 15 in which the rules include one or more of literal string (key word) matches, regular expression matches, string patterns or occurrences of text, or other linguistically defined criteria to recognize desired matches.

17. A method according to claim 16 including the step of discarding or stripping all extraneous information from the information that is retrieved including HTML tags, images and the like.

18. A method according to claim 17 in which relevant information which is the subject of a new record is stored with associated metadata.

19. A method according to claim 18 in which each record is a distinct and unique item in the database or archive and is assigned a unique identifier.

20. An automated information search and retrieval system in which real time selection and retrieval of the information occurs.

21. A system according to claim 20 including provision for archiving the retrieved information in a readily accessible manner.

22. A system according to claim 21 in which the information is searched and retrieved from the Internet.

23. A system according to claim 22 including means for establishing one or more target resource locations from which information is to be searched and retrieved.

24. A system according to claim 23 including means for spidering a target resource location to identify underlying links.

25. A system according to claim 24 including means for retrieving information from links.

26. A system according to claim 25 including means for assigning or attaching metadata to each item of information to create a database record.

27. A system according to claim 26 including means for archiving retrieved information for later analysis.

28. A system according to claim 27 including means for converting retrieved information which is not in a textual format to an editable raw-text data type.

29. A system according to claim 28 including means for providing text data from non-text sources including hard copies by conversion to text using optical character recognition processors and audio format using speech recognition applications.

30. Apparatus to implement the system of claim 20.

31. A computing machine operable to implement the system of claim 20.

32. Apparatus to implement the method of claim 1.

33. A computing machine operable to implement the method of claim 1.

34. A computing machine operable to implement the apparatus of claim 30.
